(19) United States
(12) Patent Application Publication
(10) Pub. No.: US 2026/0007983 A1
(43) Pub. Date: Jan. 8, 2026

(54) GEOLOCATION TAG AND SYSTEM FOR HORSE RACING

(71) Applicant: SportsMEDIA Technology Corporation, Durham, NC (US)

(72) Inventors: Tim Driedger, Boise, ID (US); Matthew Bertram, Phoenix, AZ (US); Isaac Walkerstern, Portland, OR (US); Kent Mason, Sunnyvale, CA (US)

(73) Assignee: SportsMEDIA Technology Corporation, Durham, NC (US)

(21) Appl. No.: 19/258,210

(22) Filed: Jul. 2, 2025

Related U.S. Application Data
(60) Provisional application No. 63/667,492, filed on Jul. 3, 2024.

(51) Int. Cl. A63K 3/00; G01S 19/43

(52) U.S. Cl. CPC A63K 3/00; G01S 19/43

(57) ABSTRACT

Survey-grade GPS devices attached to horses or jockeys transmit geolocation data to a server platform. The server platform generates statistical data, including fractional timing information and position data for each horse. The server platform generates a virtual visualization of the horse track with sprites representing each horse and facilitates live betting on results or other parameters of the horse race.

### CROSS-REFERENCES TO RELATED APPLICATIONS

This application relates to and claims priority from the following U.S. Patent Applications. This application claims priority from and the benefit of U.S. Provisional Patent Application No. 63/667,492, filed Jul. 3, 2024, which is incorporated herein by reference in its entirety.

### BACKGROUND OF THE INVENTION

### 1. Field of the Invention

The present invention relates to sensor tracking systems for horse racing, and more specifically to tracking systems including high precision, survey grade Global Positioning System (GPS) trackers without the need for large ground planes characteristic of other survey grade GPS trackers.

### 2. Description of the Prior Art

It is generally known in the prior art to provide camera systems for recording a horse race and sensors and trackers for monitoring a horse's health and position.

Prior art patent documents include the following:

U.S. Pat. No. 11,631,251 for Method and system for jockey and horse recognition and tracking by inventors Yuen et al., filed Feb. 23, 2021 and issued Apr. 18, 2023, discloses a method for jockey and horse recognition and tracking. The method includes receiving input images or a sequence of images obtained from horse racing videos or video streams; extracting features from the images by computational methods; locating jockey and horse positions of a target horse in the images by the computational methods; deciding to accept or reject the computed jockey and horse positions according to an acceptance function; and producing the final jockey and horse positions and their associated information by an error correction algorithm.

US Patent Pub. No. 2024/0107980 for Systems and methods for tracking objects over a distance by inventor Dahl, filed Oct. 3, 2022 and published Apr. 4, 2024, discloses systems and methods for tracking of objects over a distance, including for example, the tracking of horses over the course of a plurality of horse races. The disclosed system can include an ID transmitter that is associated with a particular horse and contains unique identification data. A transponder can be configured to receive the identification data from the ID transmitter and to receive positional data from a plurality of satellites. The transponder may transmit the positional data to a central tracking station in a manner that allows for the association of the positional data with the identification data.

US Patent Pub. No. 2024/0164349 for Health tracker device for horses by inventor Mort, filed Mar. 4, 2022 and published May 23, 2024, discloses a health tracker device for animals, including an electronics and hardware portion operatively attached to an expandable band, wherein the electronics and hardware portion includes a mechanism for detecting and tracking heart rate, a mechanism for detecting and tracking temperature, a mechanism for detecting and tracking position by GPS, a mechanism for detecting respiratory rate, a mechanism for detecting blood oxygen levels, a mechanism for detecting and differentiating movement (9-axis accelerometer), and a mechanism that vibrates to simulate a slow heart rate to calm an animal down. An application for monitoring health of an animal, and a method of using the application. A method of tracking the health of an animal, by securing the health tracker device to the tail of the animal, and detecting and tracking heart rate, temperature, GPS position, respiratory rate, blood oxygen levels, and movement of the animal.

US Patent Pub. No. 2024/0334902 for Tracking system and method for animal racing and/or training by inventor Scholz, filed Aug. 16, 2022 and published Oct. 10, 2024, discloses a tracking system and method for animal racing and/or training. The system comprises at least one RTK base station installed at or near a racecourse and/or training track and configured for generating calibrated GPS/GNSS data indicating a fixed location of the RTK base station and for obtaining current GPS/GNSS data of the RTK base station; one or more TAG modules configured for being moveable with respective ones of the animals along the race course and/or training track, each TAG module configured for obtaining current GPS/GNSS data of the TAG module; and a processor unit configured for generating output tracking data based on the current GPS/GNSS data of the respective TAG modules and correction data generated from the calibrated GPS/GNSS data and the current GPS/GNSS data of the RTK base station; wherein each tag module is configured for transmitting position data based on the current GPS/GNSS data of the tag module via the mobile network to the processing unit.

US Patent Pub. No. 2025/0143268 for Animal health and safety system and method by inventor Pawlick, filed Jan. 3, 2025 and published May 8, 2025, discloses a human or artificial intelligence (AI) operated animal health and safety system and method for use with animals, such as equines, other ungulates, canines and felines. Sensors/monitors/signs and sources (“DMSS”) obtain data on vital life-sustaining or life-threatening processes and signs directly from the animal. The vital life-sustaining and/or life-threatening processes and/or signs in the form of data, together with archived/real-time location/monitoring/external conditions, e.g., weather forecasts/alerts are processed in a system which can be operated partially, or almost exclusively by AI. The AI system and method re-purposes/re-re-purposes the data originally obtained for another use/diagnosis or purpose. A method of utilizing the AI system is also described.

US Patent Pub. No. 2012/0059235 for Animal Instrumentation by inventor Davies, filed Nov. 24, 2010 and published Mar. 8, 2012, discloses an approach to instrumentation and telemetry of physiological and physical parameters of an animal and its environment that has particular application to horses. This approach improves the effectiveness of one or more of evaluation, diagnosis, care conditioning or monitoring of animals because it does not require use of restrictive equipment such as force plates or treadmills, and it can provide objective and quantitative data that is complete, accurate, precise and reproducible, and this data can be obtained under real-world conditions, for either or both of more or less real-time or continuous processing of data to perform the monitoring or diagnosis. That is, in such an approach objective and quantitative data can be collected under real-world conditions and this data can be processed and the information can be displayed in a form that is familiar to experts in real-time locally, or can be stored for subsequent retrieval or transmitted for remote review.

U.S. Pat. No. 10,660,546 for Human and animal physiological comparatives, communication and developers' tool kit by inventor Saigh, filed Dec. 21, 2017 and issued May 26, 2020, discloses a sports training and guidance platform network which intertwine various wearables. The network includes at least one wearable containing one biosensor worn on a human body and one worn on a animal body, Timestamp biometric and other measurements and inputs from a data stream for both human and animals collected, analyzed, compared and accessed on one or more mobile device platforms. According, the wearable network will measure and compare various animal biosensor data, and motion i.e., accelerometers, gyroscopes with human biosensor data. A sports training toolkit which includes wearable biosensors, sensors, secure wearable communication network(s) and platform and system, applications and database information is also provided.

U.S. Pat. No. 10,675,524 for Horse training goggle assembly by inventor Arguello, filed Oct. 31, 2018 and issued Jun. 9, 2020, discloses a horse training goggle assembly including a pair of goggles that may be worn by a jockey riding a horse during race training. The goggles have a frame and a lens that is removably positioned in the frame. A tracking unit is coupled to the goggles and the tracking unit is in electrical communication with a global positioning system (GPS) to identify a physical location of the jockey. Moreover, the tracking unit calculates a speed and direction of the horse during the race training. A display is embedded within the lens and the display is visible to the jockey when the goggles are worn. The display displays indicia in the lens and the display is electrically coupled to the tracking unit to display data relating to the speed and direction of the horse. A communication unit is coupled to the goggles for verbal communication between the jockey and the trainer.

U.S. Pat. No. 11,931,668 for Measuring system for horse race or training by inventor Pleszinger, filed Jan. 9, 2020 and issued Mar. 19, 2024, discloses a measuring system for horse races or training. The measuring system including at least one base station on a horse track or around the horse track, and at least one transponder module placed on at least one movable object, which is composed by a jockey and a horse of the jockey, in order to establish a wireless communication with the base station(s). The transponder module is placed on the body of the jockey, and preferably at the back of the jockey or a visible up-part of the horse.

U.S. Pat. No. 10,231,669 for Equine performance tracking and monitoring system by inventors Wordham et al., filed Jun. 18, 2018 and issued Mar. 19, 2019, discloses an equine performance tracking and monitoring system having real-time feedback including a horse heart rate monitoring strap configured to be secured against a portion of a horse while extending only part of the way around the horse. To measure the horse's heart rate, the disclosed systems may utilize such a discrete-length horse heart rate monitoring strap having electrodes, one of which is positioned behind the left elbow of the horse. The horse's heart rate may be transmitted to a wearable device work by a rider. The wearable device may include a sensor configured to measure the heart rate of the rider. The heart rate of the horse and the heart rate of the rider may each be presented to the rider, for example, via a display of the wearable device.

U.S. Pat. No. 10,624,320 for Rider notification apparatus and method by inventors Lombardo et al., filed Aug. 17, 2017 and issued Apr. 21, 2020, discloses apparatuses and methods useful for providing a visual indication to the rider of a horse of one or more inputs, such as the pitch of the head of a horse. The apparatuses and methods are useful in connection with the sport of dressage. The rider can be notified of a position or orientation of the horse's head, of rein tension, of the rider's body position or orientation, of a current location within a course or routine, of a warning, or of other information. The visual indication can be in the form of an illuminated light source.

US Patent Pub. No. 2006/0173367 for Equine fitness monitoring by inventors Stuart et al., filed Mar. 26, 2004 and published Aug. 3, 2006, discloses an apparatus for determining the health or fitness, under an exercise load, of an animal such a horse comprising: a first sensor (incorporated in module and having electrodes, positioned in blanket under saddle of a horse, generating physiological data, e.g. breathing or heart rate, blood pressure or flow, temperature, etc; a second sensor, also incorporated in module, for generating position data, e.g. a GPS sensor having antenna. By using an algorithm, a fitness indicator such as velocity at a heart rate of 200 beats per minute (V-200) can then be derived using data from the sensors. Lameness, disease or poor physiological potential of the animal can thus be identified.

U.S. Pat. No. 8,145,448 for System and process for charting and displaying the time and position of contestants in a race by inventor Vincenzini, filed Dec. 21, 2006 and issued Mar. 27, 2012, discloses a system and a process for determining the timing and position of contestants on a track. This system comprises at least one directional antenna in communication with at least one competitor communication device that can be coupled to each contestant. A remote base station, is in communication with the positioning device, wherein the positioning device determines a contestant time as the contestant passes the projected field and also determines the position of the contestant in relation to an inside guide such as a rail. There is also a process which includes attaching at least one competitor communication device on at least one contestant, starting a race, and then recording the position and time for each contestant and transmitted from the competitor communication device to a remote base station.

WIPO Patent No. 2011/116421 for Method, system and apparatus for tracking and monitoring moving objects by inventors Hildebrandt et al., filed Mach 24, 2011 and published Sep. 29, 2011, discloses tracking objects and determining their position and/or progress and performance over time. In one form the invention provides a method of tracking at least one moving object traversing a predefined course, the method comprising the steps of: emitting line-of-sight EM radiation from at least one beacon, each beacon located to provide a means of reference for said at least one moving object; capturing at least one image including a representation of the transmitted EM radiation by digital image recording at one or more of a plurality of predetermined locations relative to the predefined course; extracting position information of the at least one transmitting beacon from the at least one captured image relative to each frame of the captured image; referencing each extracted position with predetermined survey data of the predefined course, to produce referenced position data; generating a model of the path traversed by the at least one moving object on the predefined course using the referenced position data.

Korean Patent No. 101075579 for Real-time position recognition system by inventors Hildebrandt et al., filed Mach 24, 2011 and published Sep. 29, 2011, discloses a real-time position recognition system of a race object, to provide a fast, transparent, accurate game management system by applying the RFID method to the racing races having a relative ranking contest, and to locate the position of a large number of participants in the long distance race And it is to provide a real-time location recognition system of the race target that can be confirmed in real time in the middle position in the distance. The invention is attached to each race object to provide the unique information of the participant, the individual identification information of the participant with a bar code and the electronic tag to output a specific frequency and different identification power between each other An information providing module including an RFID tag for transmitting a unique ID value and a GPS transmitter for providing location information through a GPS satellite; It is formed in the movement path of the race object and determines whether it passes, and then transfers it to the race management server, the RFID reader for receiving the radio signal transmitted from the RFID tag, CDMA An RFID location measurement module including a CDMA transmitter for transmitting the RFID tag information sensed using the mobile communication network to a game management server located at a far distance; By managing the respective records for the plurality of racing targets and monitoring the current position, the barcode reader for reading each barcode information attached to the racing target, GPS satellites GPS receiver for tracking the position of the GPS transmitter attached to the race object through the, and the CDMA receiver for receiving the RFID tag information transmitted through the CDMA mobile communication network and a game operation server including a database in which the registered information of the participant and the game record information are stored.

French Patent No. 3098309 for System for tracking a plurality of racehorses during a horse race and associated tracking method by inventor Reeves, filed Jul. 5, 2019 and issued Jan. 21, 2022, discloses a system for tracking a plurality of racehorses during a horse race and associated tracking method. The invention relates to a system for tracking a plurality of racehorses during a horse race comprising: a plurality sensors fitted to the horses, each sensor being configured to periodically generate a parameter relating to the horse and to periodically transmit this parameter during a transmission time interval; a centralized module comprising at least one chip configured to communicate with part of the sensors; Each sensor is capable of switching between a low energy configuration associated with a low energy emission interval and a high energy configuration associated with a high energy emission interval, the high energy interval being smaller than the low energy interval. Each sensor comprises means for switching between the two configurations depending on the progress of the horse race

### SUMMARY OF THE INVENTION

The present invention relates to sensor tracking systems for horse racing, and more specifically to tracking systems including high precision, survey grade GPS trackers without the need for large ground planes characteristic of other survey grade GPS trackers.

It is an object of this invention to provide a more accurate system and method for tracking horse locations during a horse race and using this information to generate graphics and statistical data regarding horse performance, able to be used for visualization and/or live-betting for the horse race.

In one embodiment, the present invention is directed to a system of live geolocation for a horse race event, including at least one jockey vest, configured to be worn by at least one jockey of at least one horse, at least one geolocation tag connected to the at least one jockey vest, a plurality of base stations positioned around a horse race track configured to receive telemetry data from the at least one geolocation tag, and at least one server, including a processor and memory, configured to receive and process the telemetry data from the plurality of base stations, wherein the at least one geolocation tag is configured to receive L1, L2, and L5 signals, wherein the at least one server determines positions of the at least one horse based on the telemetry data, and wherein the positions of the at least one horse on the horse race track are displayed on one or more user devices.

In another embodiment, the present invention is directed to a method of live geolocation for a horse race event, including at least one geolocation tag connected to at least one jockey vest receiving and processing geolocation data from at least one geolocation satellite, and transmitting telemetry data, a plurality of base stations positioned around a horse race track receiving the telemetry data from the at least one geolocation tag, at least one server, including a processor and memory, receiving and processing the telemetry data from the plurality of base stations, the at least one server determining positions of at least one horse based on the telemetry data, and one or more user devices displaying the positions of the at least one horse on the horse race track, wherein the at least one geolocation tag is configured to receive L1, L2, and L5 signals.

In yet another embodiment, the present invention is directed to a system of live geolocation for a horse race event, including at least one jockey vest, configured to be worn by at least one jockey of at least one horse, at least one geolocation tag connected to the at least one jockey vest, a plurality of base stations positioned around a horse race track configured to receive telemetry data from the at least one geolocation tag, and at least one server, including a processor and memory, configured to receive and process the telemetry data from the plurality of base stations, wherein the at least one geolocation tag is configured to receive L1, L2, and L5 signals, and wherein the at least one server is integrated with at least one real-time betting system, and wherein the at least one real-time betting system changes betting odds or pays out bets based on the telemetry data.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a virtual representation of a horse track generated based on live sensor data according to one embodiment of the present invention.

FIG. 2 illustrates a dashboard view of a horse race including a leaderboard and a virtual track according to one embodiment of the present invention.

FIG. 3 illustrates a chart of fractional split times generated by the system according to one embodiment of the present invention.

FIG. 4 illustrates a broadcast screen view including a superimposed lane graphic according to one embodiment of the present invention.

FIG. 5 illustrates a back view of a vest with a sensor embedded in the vest or attached to the vest according to one embodiment of the present invention.

FIG. 6 illustrates a block diagram of a tag for tracking location of a horse and horse jockey according to one embodiment of the present invention.

FIG. 7 is a schematic diagram of a system of the present invention.

### DETAILED DESCRIPTION

The present invention is generally directed to sensor tracking systems for horse racing, and more specifically to tracking systems including high precision, survey grade GPS trackers without the need for large ground planes characteristic of other survey grade GPS trackers.

In one embodiment, the present invention is directed to a system of live geolocation for a horse race event, including at least one jockey vest, configured to be worn by at least one jockey of at least one horse, at least one geolocation tag connected to the at least one jockey vest, a plurality of base stations positioned around a horse race track configured to receive telemetry data from the at least one geolocation tag, and at least one server, including a processor and memory, configured to receive and process the telemetry data from the plurality of base stations, wherein the at least one geolocation tag is configured to receive L1, L2, and L5 signals, wherein the at least one server determines positions of the at least one horse based on the telemetry data, and wherein the positions of the at least one horse on the horse race track are displayed on one or more user devices.

In another embodiment, the present invention is directed to a method of live geolocation for a horse race event, including at least one geolocation tag connected to at least one jockey vest receiving and processing geolocation data from at least one geolocation satellite, and transmitting telemetry data, a plurality of base stations positioned around a horse race track receiving the telemetry data from the at least one geolocation tag, at least one server, including a processor and memory, receiving and processing the telemetry data from the plurality of base stations, the at least one server determining positions of at least one horse based on the telemetry data, and one or more user devices displaying the positions of the at least one horse on the horse race track, wherein the at least one geolocation tag is configured to receive L1, L2, and L5 signals.

In yet another embodiment, the present invention is directed to a system of live geolocation for a horse race event, including at least one jockey vest, configured to be worn by at least one jockey of at least one horse, at least one geolocation tag connected to the at least one jockey vest, a plurality of base stations positioned around a horse race track configured to receive telemetry data from the at least one geolocation tag, and at least one server, including a processor and memory, configured to receive and process the telemetry data from the plurality of base stations, wherein the at least one geolocation tag is configured to receive L1, L2, and L5 signals, and wherein the at least one server is integrated with at least one real-time betting system, and wherein the at least one real-time betting system changes betting odds or pays out bets based on the telemetry data.

As sports betting is legalized in more jurisdictions in the United States, there is a need for more exact statistics able to be used to generate more specific bets, more informed data for those making bets, and more precision to determine winners of specific bets. For many racing sports, this precision means greater specificity in stats for the speed and position of the racing object (e.g., the horse). Furthermore, some have proposed the use of Global Positioning System (GPS) data to help predict injuries to horses (i.e., via gait analysis) and to help reduce some of the harm to the animals in the sport. However, the precision of these stats is limited by current sensor or camera equipment, especially when it comes to statistics such as fractional split times.

Prior art systems described in patents such as U.S. Pat. Nos. 11,931,668 and 10,675,524 have proposed attachment of GPS sensors of some form to a jockey to track horses. Health monitoring, or potentially health-conscious training, is the most common use of GPS sensors, which are typically listed among a litany of other physiological sensors, including heart rate or blood pressure sensors. For health monitoring, typical recreational GPS sensors are typically adequate, and survey grade GPS sensors are not described. The GPS sensors described in the prior art are not adequate for generating race location data and training data for applications such as tracking performance and betting, which require greater precision of location.

In horse racing, some systems currently being used, such as the GMAX system, provide high level information and analysis including position information but fail to provide the sort of raw and precise data that is necessary for highly informed live betting, live graphical insertion, or real-time graphical visualization. These systems also do not provide for obtaining quick and interesting replays of critical race events.

GPS sensors traditionally come in three different grades, differentiated by the degree of precision they are able to achieve. Recreational grade GPS receivers are the most common forms of receivers and are used in devices such as vehicles or smartphones. Recreational grade GPSA receivers often have an accuracy of about 30 meters, with smartphones and other electronic devices which incorporate recreational grade GPSA receivers often using additional location tracking methods to increase accuracy to within approximately 5 meters. This makes recreational grade receivers adequate for larger scale routing, but too inaccurate for the scale of activities such as tracking precise locations of horses during a race. Map grade GPS receivers most commonly have an accuracy of 3-5 meters, though potentially down to about 1 meter, with the cost scaling with increasing accuracy. Survey grade receivers have the best accuracy, defined as within one meter (though some have far greater accuracies). These receivers typically come in the form of bulky tri-pod mounted antennas, although handheld versions exist as well.

One challenge with GPS sensors, especially those with greater precision, is the effect of multipath (i.e., errant, often reflected GPS signals that decrease accuracy). This ground plane, often formed as a metal disk or ground plate, acts as a shield for radiofrequency (RF) radiation, at least from one direction. For smaller, handheld devices, these ground planes are relatively small, often being directly attached to the circuit board, while for larger antennas, these ground planes sometimes come in the form of meters-wide disks. Signal reception tends to increase with the increasing size of the ground plane, at least up to a point, as signals from more and more angles are blocked. These ground planes, however, come with the disadvantage of both weight and size, which is especially inconvenient for a racing activity, where even a bit of extra deadweight directly impacts performance. Thus, what is needed is a high-accuracy, even survey-grade, GPS receiver able to be attached to a jockey or a horse for generating precise location data during a horse race.

Referring now to the drawings in general, the illustrations are for the purpose of describing one or more preferred embodiments of the invention and are not intended to limit the invention thereto.

Although the present invention is described particularly for use in horse racing, one of ordinary skill in the art will understand that the disclosure of this invention is able to apply to other animal racing events, such as camel racing. One or more survey-grade geolocation sensors (e.g., global positioning system (GPS) sensors) are attached to each horse and/or to each jockey. Geolocation sensors are able to be placed on different areas of the jockey and/or horse, including but not limited to, a helmet, collar, vest, beltline, or other parts of the horse jockey, or to the saddle cloth or other parts of the horse. In the most preferred embodiment, the system includes at least one tracking tag including geolocation sensors directly attached to or fitted inside a protective vest of a jockey, more particularly in the middle back of the vest. In one embodiment, the system includes 4 geolocation sensors attached to the back of the jockey silk of each jockey. In another embodiment, the system only requires a single sensor per horse, placed on the helmet, helmet cover, back of the jockey silk, top of the saddle cloth, or the side of the saddle cloth, reducing the amount of complication and cost. The survey-grade geolocation sensor is defined as having a precision of at least 1 meter. In one embodiment, the geolocation sensor provides carrier-phase corrected real-time kinematic (RTK)-FIX status, with a precision of better than or less than approximately 2 cm for the entire race. The geolocation sensor is operable to generate 2D or 3D geolocation coordinate data, either in reference to a global standard (e.g., latitude/longitude), or relative to a different or custom standard location.

The survey-grade geolocation sensor is preferably a tag approximately the size of a pager (e.g., less than 300 mm along each dimension of the sensor). In one embodiment, the survey-grade geolocation sensor does not include a ground plane, instead allowing the horse itself to effectively be used as the ground plane for the geolocation sensor by blocking reflected multipath signals from low angles. Surprisingly, by including the sensor as an attachment to the lower portion of the back of an article of clothing of a jockey, such as on the exterior of a protective vest, the present invention provides superior geolocation compared to the prior art. The location of the sensor on a jockey vest, and more particularly, the lower portion of a jockey vest, provides for blocking of more reflected multipath signals from low angles by the horse than other positions for the sensor on a jockey or a horse during a race because the sensor is closer to the horse compared to if the sensor were mounted or attached to another part of the jockey, such as the helmet of the jockey. This provides for the horse to act as an effective ground plane. However, other positions of the sensor, such as the sensor being attached to or embedded in a belt, a strap, or a belt-like strap worn by a jockey on or around a vest, provide for adequate geolocation of the jockey during a race for the location tracking functionality of the present invention. The use of the horse as the ground plane for the geolocation sensor reduces the overall weight of the sensor, thereby decreasing the impact of the sensor on the overall weight on the horse. In one embodiment, the geolocation sensor is less than approximately 100 g in weight, more preferably less than about 70 g in weight, and even more preferably less than 60 g in weight. In another embodiment, a small ground plane is included in a housing of the geolocation sensor.

In one embodiment, the geolocation sensor is paired with or includes at least one inertial measurement unit (IMU), at least one 3-axis accelerometer, at least one gyroscope, and/or at least one compass for providing additional information regarding the movement and/or orientation of each horse or jockey.

In one embodiment, the survey grade geolocation sensor (and/or other associated sensors) is operable to transmit signals to one or more servers, nodes, and/or remote processors constituting components of a server platform. The signals are preferably transmitted through radio link telemetry. In one embodiment, the signals are transmitted via radiofrequency (RF) signals, ultra-wideband (UWB) signals, infrared (IR) signals, cellular signals, and/or other signal types. In one embodiment, the signals include unique IDs for each geolocation sensor as metadata, allowing for the received geolocation data to be matched to a particular horse.

In one embodiment, the signals are transmitted as RF signals with a frequency of approximately 2395 MHz or between approximately 901-905 MHz. The frequency range of between about 2360 and 2390 MHz is able to be used as a backup for signals. In one embodiment, 5G cellular networks and/or WI-FI signals are able to be used as a backhaul for the system. In another embodiment, an approximately 900 MHz + 2.4 GHz radio backhaul is used, without the need for dependence upon cellular networks.

In one embodiment, additional sensor data is able to be used to supplement and/or verify the geolocation data. By way of example and not limitation, in one embodiment, one or more cameras are able to generate and transmit visual sensor data to the server platform. In one embodiment, the one or more cameras are stationary, movable-on-track, or drone-based cameras.

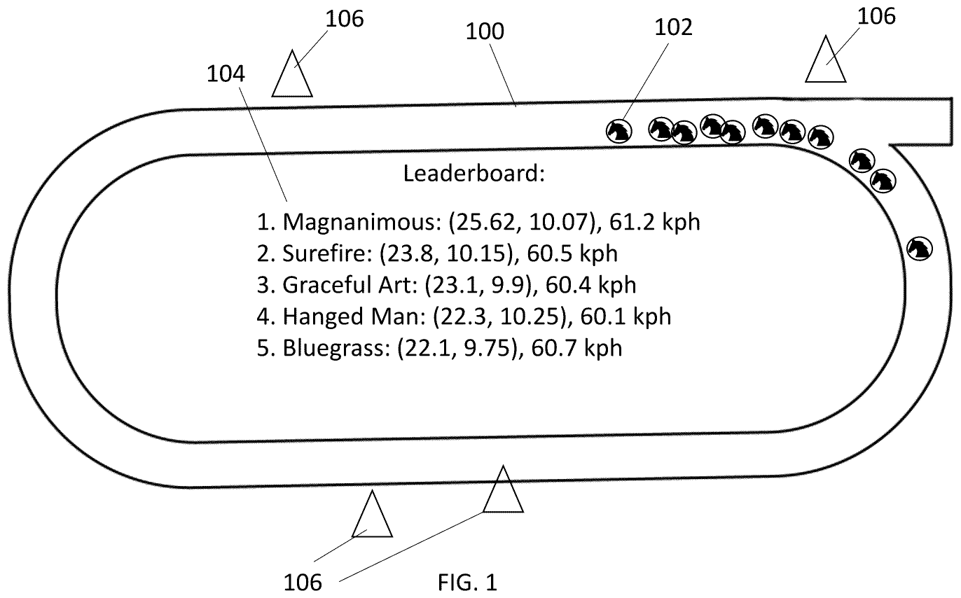

FIG. 1 illustrates a virtual representation of a horse track generated based on live sensor data according to one embodiment of the present invention. In one embodiment, the server platform is operable generate a visualization of a horse track 100 that is able to be displayed on an app or website on a user device (e.g., a mobile phone, a tablet, a computer, etc.). Based on data from a plurality of geolocation sensors, the server platform populates the visualization of the horse track with sprites 102 representing each horse. In one embodiment, the sprites 102 include a photograph or other visual graphic representing each specific horse, while, in another embodiment, a generic placeholder image, image of the jockey, or other images are utilized. The visualization is able to update in real-time, without discernable delay, allowing users to follow the horse race in real time. In one embodiment, the system is able to implement a system for generating a representation of a sporting event including sprite representations of individual participants in the event, as disclosed in U.S. patent application Ser. No. 18/086,168, which is incorporated herein by reference in its entirety. In one embodiment, the visualization of the horse track is a three dimensional (3D) representation.

In one embodiment, a plurality of base stations 106, including receiver antennas, are placed around the horse track to quickly receive data from the sensors attached to each horse or jockey. In one embodiment, two base stations 106 are placed such that they are proximate to the far ends of the track, near where the turns occur. In one embodiment, one or more receivers are placed on the grandstand (e.g., on the roof of the grandstand) of the horse track. In one embodiment, there are 3-4 receivers placed on the grandstand. In one embodiment, the system includes a total of between 4-6 base stations 106 having receiver antennas around the horse track, though one of ordinary skill in the art will understand that systems with greater or fewer numbers of base stations 106 and receivers are contemplated herein. In one embodiment, one or more of the base stations includes a real-time kinematic positioning (RTK) correction transmitter antenna for transmitting correction data to other base stations or to the geolocation sensors themselves to automatically update the geolocation model being used to account for various factors.

In one embodiment, the visualization includes a list of horses 104 with statistical data for one or more of the horses. In one embodiment, the statistical data includes coordinates for one or more of the horses (preferably for each of the horses). In one embodiment, the visualization includes current speeds of one or more of the horses, top speeds of one or more of the horses, split times for one or more of the horses, recent or top lap times, and/or other statistical data regarding the horses. A processor of the server platform is able to determine parameters such as the instantaneous speed of the horse based on detecting differences in geolocation coordinates received from the same horse at different times. This is also able to be used to generate fractional split times for smaller distances, such as 0.125 miles (0.2 km) or 0.25 miles (0.4 km) or other distances.

In one embodiment, the server platform provides for an in-app or on-website live betting system. In one embodiment, the live betting system includes traditional betting lines related to the horse race, including betting on the winner or ultimate positions of each of the horses, or more specific types of bets, including a trifecta, superfecta, exacta, daily double, quinella, show, pick 3, and/or other types of bets. However, the live betting system is also able to have additional types of bets, including those based on fractional times (e.g., fastest quarter mile), top speeds, lap times, or other parameters, where such bets are able to be automatically decided based on data from the geolocation sensors. In one embodiment, the bets are generated by the server platform or operator, while, in another embodiment, the platform allows for user-led bets. In one embodiment, bets are generated by a machine learning module based on the geolocation data. In one embodiment, betting odds are automatically updated on a display for an application or website for one or more bets based on the sensor data received by the server platform.

In one embodiment, the live betting system is implemented using a distributed ledger architecture, such as a blockchain-implemented architecture. In this way, the system is able to utilize smart contracts to automatically execute the payouts of the betting system. In another embodiment, the automatic payouts are made without the use of blockchain or any other distributed ledger system. In one embodiment, the betting system is able to accept external cryptocurrencies (e.g., bitcoin, Ether, etc.), fiat currencies (e.g., dollars, euros, etc.), and/or internal app credits. Systems for live-betting on sports compatible to be used with the present invention include, but are not limited to, those described in U.S. Pat. No. 10,453,311, which is incorporated herein by reference in its entirety.

In one embodiment, the server platform is operable to provide replays of previous races and is operable to superimpose ghost images of a horse in a previous race on a current or other previous race so that the performance of that horse in one race is able to be compared with the field of horses in a different race. Systems of implementing ghost images of race participants based on previous race data and otherwise displaying races that are compatible with the present invention include, but are not limited to, those described in U.S. Pat. No. 11,240,569, which is incorporated herein by reference in its entirety.

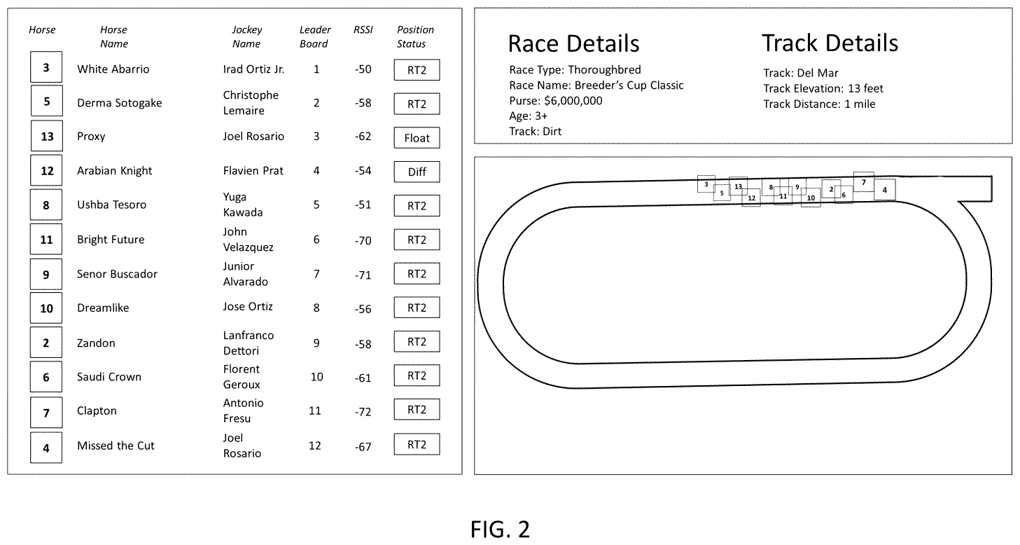

FIG. 2 illustrates a dashboard view of a horse race including a leaderboard and a virtual track according to one embodiment of the present invention. In one embodiment, a leaderboard is able to be displayed to the left or in any other orientation relative to a live-updating track graphic. In one embodiment, the dashboard provided on an application or website associated with the present invention includes basic race details (e.g., location, track type, total betting line, race name, track name, track elevation, track distance, age of track, etc.). In one embodiment, a leaderboard is operable to display a ranked list of horses in the race and is operable to update in real time as horses pass each other. In one embodiment, the leaderboard includes information including, but not limited to, horse number, horse name, jockey name, an image of the jockey silk, ranking, a received signal strength indicator (RSSI), and/or a position status for the horse.

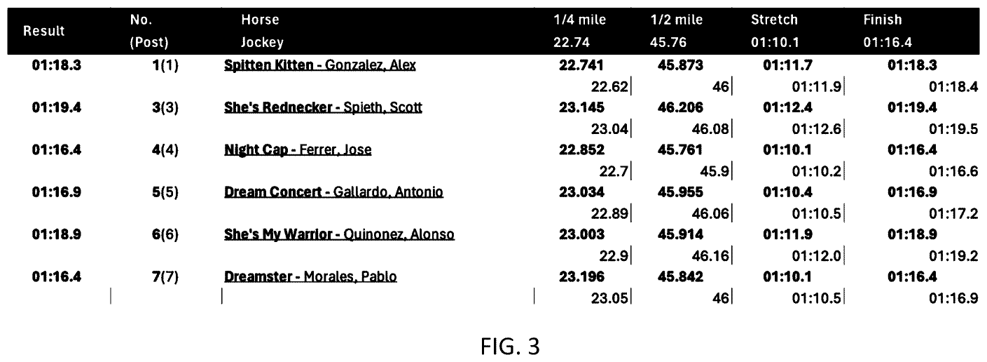

FIG. 3 illustrates a chart of fractional split times generated by the system according to one embodiment of the present invention. As mentioned above, fractional split times are able to be generated based on the real-time geolocation data and provide more granular raw data regarding horse performance over time or relative to a preexisting benchmark.

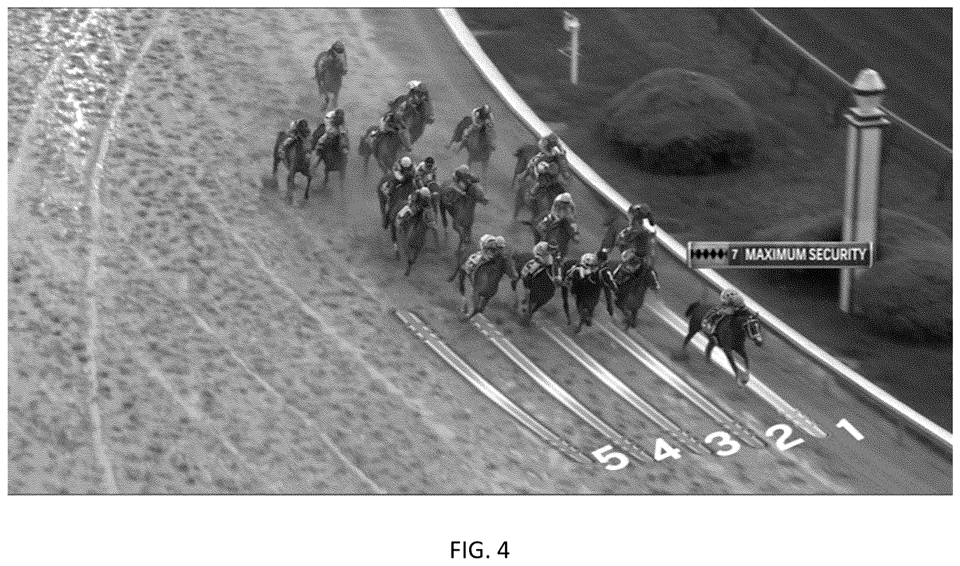

FIG. 4 illustrates a broadcast screen view including a superimposed lane graphic according to one embodiment of the present invention. In one embodiment, a machine learning module of the server platform is operable to generate an optimal line for each particular horse based on data from multiple different laps and races, and/or estimated speeds or times for each particular horse for upcoming races. In one embodiment, the optimal line, estimated speeds, and/or estimated times for each of the horses is based on factors of the racing grounds of previous races (e.g., soil, weather, temperature, particular jockey, etc.). This is useful for encouraging engagement with the race by allowing users to identify live whether particular horses have been following optimal lines or beating or lagging behind prior expectations. In one embodiment, the estimate models are operable to update in real time based on the current performance of the horse.

In one embodiment of the present invention, the server platform is operable to generate a display showing live footage of a horse racing event or 2D or 3D generated graphical versions of the horse racing event based on the received sensor data. In one embodiment, the display includes a plurality of windows showing either a plurality of angles of the same horse racing event or a plurality of different concurrent or historical horse racing events simultaneously. In one embodiment, the system is operable to automatically superimpose various graphics on the broadcast or on the graphical versions, including but not limited to pointers indicating the real time positions of one or more specific horses. Examples of systems able to superimpose optimal racing lines and/or current average racing lines for race participants that are able to be used with the present invention include, but are not limited to, those described in U.S. Pat. No. 11,240,569, which is incorporated herein by reference in its entirety.

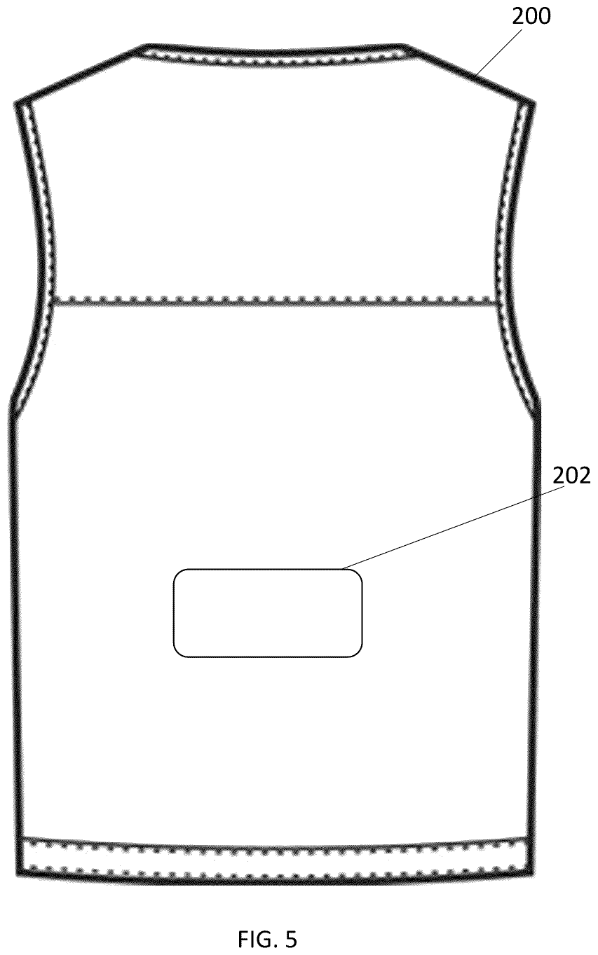

FIG. 5 illustrates a back view of a vest with a sensor embedded in the vest or attached to the vest according to one embodiment of the present invention. As mentioned above, in one embodiment, a vest 200 worn by a jockey includes a sensor 202 placed on or embedded in a back portion of the vest 200. In one embodiment, the sensor 202 is attached to the lower back portion of the vest 200. The sensor placement on the lower portion of the vest as illustrated in FIG. 5 provides blocking of reflected multipath signals from low angles by the horse while the jockey is riding the horse and improves precision for the present invention. In one embodiment, the sensor 202 is on the middle back of the vest 200. In one embodiment, the sensor 202 is on the lower middle back of the vest 200. In one embodiment, the sensor 202 is on the upper back of the vest 200. In one embodiment, the sensor 202 is on the upper middle back of the vest 200. In one embodiment, the sensor 202 is horizontally in the middle of the vest 200 or centered in the horizontal middle of the vest. In one embodiment, the sensor 202 is positioned toward the left of the vest 200. In one embodiment, the sensor 202 is positioned toward the right of the vest 200.

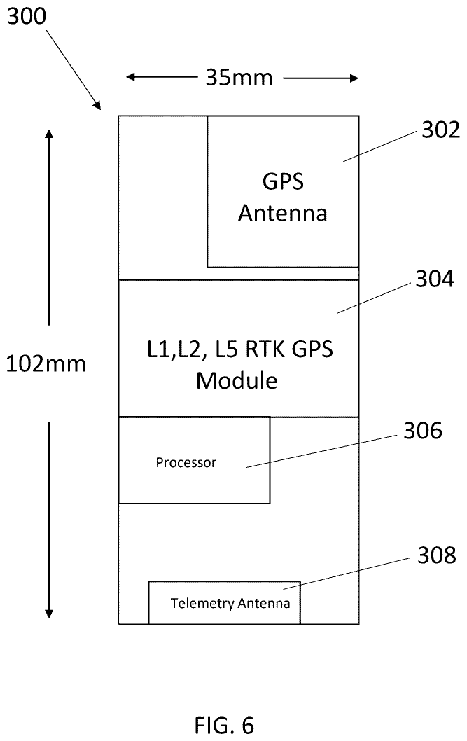

FIG. 6 illustrates a block diagram of a tag for tracking location of a horse and horse jockey according to one embodiment of the present invention. Important to the present invention is that the system utilizes a tag device 300 that is compact and relatively low weight while still providing geolocation data with sufficient fidelity to accurately locate the horse at all times. The size and weight of the tag is important as tags with too high weight or size would be uncomfortable or even dangerous to the horse and jockey team and would also more significantly slow down the competitors due to the increased weight.

In one embodiment, the tag device 300 includes, at least, a GPS antenna 302, a GPS module 304, a processor 306, and a telemetry antenna 308. In one embodiment, the tag device 300 has a length of approximately 102 mm or less. In one embodiment, the tag device 300 has a length of approximately 100 mm or less. In one embodiment, the tag device 300 has a length between about 80 mm and 120 mm. In one embodiment, the tag device 300 has a width of approximately 35 mm or less. In one embodiment, the tag device 300 has a width between approximately 30 mm and 40 mm. In one embodiment, the length-to-width ratio of the tag device 300 is approximately 3:1. In one embodiment, the length-to-width ratio of the tag device is between about 2:1 and about 4:1.

The GPS antenna 302 receives GPS signals from one or more satellites, while the GPS module 304 receives and processes the signals to determine the location of the GPS receiver. The telemetry antenna 308 then communicates the determined geolocation data to a remote processor and/or database for use in generating and displaying geolocations of each participant.

In a preferred embodiment, the GPS module 304 of the tag device is able to receive and process L1, L2, and L5 signals. Different GPS signals operate at different frequencies and offer different levels of precision in tracking, with L5 signals providing the greatest degree of precision. L1 signals operate at a frequency of 1575.42 MHz and are typically the simplest signals for GPS modules to receive, though the signals are not effective at traveling through obstacles and therefore information is sometimes spotty and easily dropped. L2 signals utilize a frequency of 1227.60 MHz and pass through obstacles more easily than L1 signals. L5 signals operate at a frequency of 1176 MHz and provide the greatest degree of precision and the highest reliability. However, L5 signals have not commonly been used outside of military applications or other high-risk applications due to the relative size of receivers traditionally required.

While L1 signals, or L1 and L2 signals in combination, are able to provide high accuracy, even up to 1 cm, traditional methods of geolocation require a long time (e.g., 10 min) to achieve that accuracy and the signal is able to be easily interfered with. The time delay in achieving necessary precision makes the use of L1 or the combination of L1 and L2 alone impractical for use in races, where races are typically over within 10 min and where accuracy in geolocation from the start is important.

In one embodiment, the GPS module 304 utilizes real-time kinematic (RTK) positioning in order to determine the precise geolocation (e.g., centimeter-level accuracy) of the horse and/or jockey. However, one of ordinary skill in the art will understand that the present invention is also capable of utilizing other positioning techniques, including but not limited to post-processing kinematic (PPK), precise point positioning (PPP), and/or other methods.

In one embodiment, the geolocation data generated by the tag attached to the jockey and/or the horse is determinative of the winner of the race by detecting which horse crosses a threshold boundary (i.e., the finish line) first by means of comparison of the geolocation data to the known geolocation of the threshold boundary. In this embodiment, the geolocation data is able to be used to supplement or even replace the use of photobeam and photo finish technology to more precisely determine the winner of a race in instances where the competitors are closely packed at the finish line.

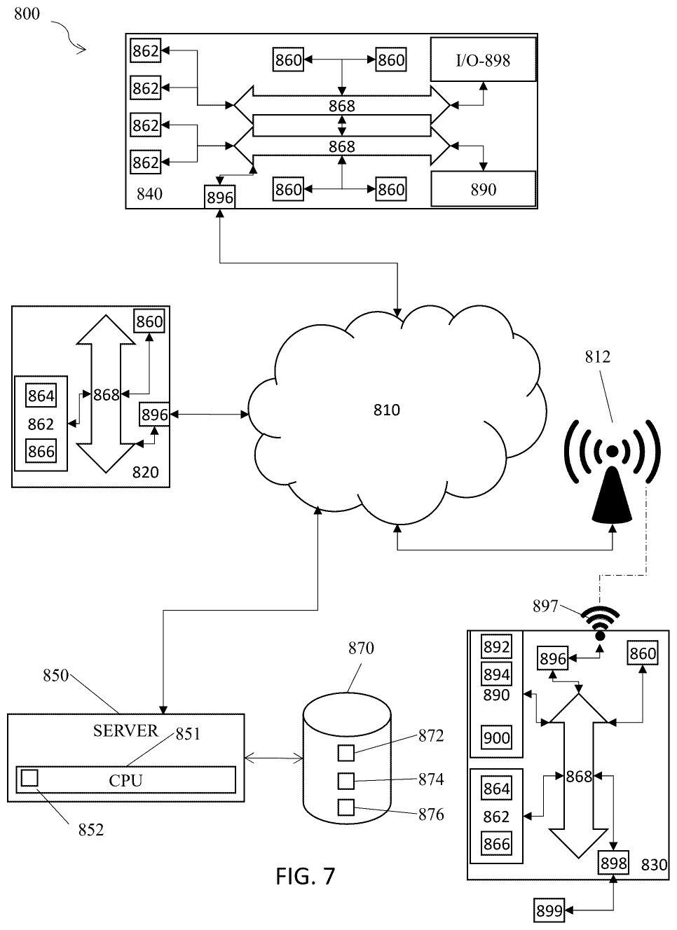

FIG. 7 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 7, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 7, is operable to include other components that are not explicitly shown in FIG. 7, or is operable to utilize an architecture completely different than that shown in FIG. 7. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system of live geolocation for a horse race event, comprising:
at least one jockey vest, configured to be worn by at least one jockey of at least one horse;
at least one geolocation tag connected to the at least one jockey vest;
a plurality of base stations positioned around a horse race track configured to receive telemetry data from the at least one geolocation tag; and
at least one server, including a processor and memory, configured to receive and process the telemetry data from the plurality of base stations;
wherein the at least one geolocation tag is configured to receive L1, L2, and L5 signals;
wherein the at least one server determines positions of the at least one horse based on the telemetry data; and
wherein the positions of the at least one horse on the horse race track are displayed on one or more user devices.

2. The system of claim 1, wherein the at least one geolocation tag further includes at least one inertial measurement unit (IMU).

3. The system of claim 1, wherein the at least one server determines an instantaneous speed and/or an acceleration of the at least one horse based on the telemetry data.

4. The system of claim 1, wherein the at least one geolocation tag is positioned on a lower back portion of the at least one jockey vest.

5. The system of claim 1, wherein the at least one geolocation tag has a length of approximately 100 mm and a width of approximately 35 mm.

6. The system of claim 1, wherein the at least one server is integrated with at least one real-time betting system, and wherein the at least one real-time betting system changes betting odds or pays out bets based on the telemetry data.

7. The system of claim 1, wherein the at least one geolocation tag utilizes real time kinematic (RTK) positioning to process geolocation signals received via at least one geolocation antenna.

8. The system of claim 1, wherein an outcome of the horse race event is determined by comparison of the telemetry data to at least one threshold.

9. A method of live geolocation for a horse race event, comprising:
at least one geolocation tag connected to at least one jockey vest receiving and processing geolocation data from at least one geolocation satellite, and transmitting telemetry data;
a plurality of base stations positioned around a horse race track receiving the telemetry data from the at least one geolocation tag;
at least one server, including a processor and memory, receiving and processing the telemetry data from the plurality of base stations;
the at least one server determining positions of at least one horse based on the telemetry data; and
one or more user devices displaying the positions of the at least one horse on the horse race track;
wherein the at least one geolocation tag is configured to receive L1, L2, and L5 signals.

10. The method of claim 9, wherein the at least one geolocation tag further includes at least one inertial measurement unit (IMU).

11. The method of claim 9, further comprising the at least one server determining an instantaneous speed and/or an acceleration of the at least one horse based on the telemetry data.

12. The method of claim 9, wherein the at least one geolocation tag is positioned on a lower back portion of the at least one jockey vest.

13. The method of claim 9, wherein the at least one geolocation tag has a length of approximately 100 mm and a width of approximately 35 mm.

14. The method of claim 9, wherein the at least one server is integrated with at least one real-time betting system, and wherein the at least one real-time betting system changes betting odds or pays out bets based on the telemetry data.

15. The method of claim 9, further comprising the at least one geolocation tag utilizing real time kinematic (RTK) positioning to process geolocation signals received via at least one geolocation antenna.

16. The method of claim 9, further comprising determining an outcome of the horse race event by comparison of the telemetry data to at least one threshold.

17. A system of live geolocation for a horse race event, comprising:
at least one jockey vest, configured to be worn by at least one jockey of at least one horse;
at least one geolocation tag connected to the at least one jockey vest;
a plurality of base stations positioned around a horse race track configured to receive telemetry data from the at least one geolocation tag; and
at least one server, including a processor and memory, configured to receive and process the telemetry data from the plurality of base stations;
wherein the at least one geolocation tag is configured to receive L1, L2, and L5 signals; and
wherein the at least one server is integrated with at least one real-time betting system, and wherein the at least one real-time betting system changes betting odds or pays out bets based on the telemetry data.

18. The system of claim 17, wherein the at least one geolocation tag further includes at least one inertial measurement unit (IMU).

19. The system of claim 17, wherein the at least one server determines an instantaneous speed and/or an acceleration of the at least one horse based on the telemetry data.

20. The system of claim 17, wherein the at least one geolocation tag is positioned on a lower back portion of the at least one jockey vest.
